(19) United States
(12) Patent Application Publication
(10) Pub. No.: US 2026/0244743 A1
(43) Pub. Date: Aug. 20, 2026

(54) DETECTING GENERATIVE ARTIFICIAL INTELLIGENCE VIDEO THREATS IN EMAIL

(71) Applicant: Cisco Technology, Inc., San Jose, CA (US)

(72) Inventors: Jan Brabec, Praha 5 (CZ); Radek Starosta, Praha (CZ); Tomas Sixta, Praha 4 (CZ); Jiri Mensik, Praha 4 (CZ); Lukas Bajer, Liberec (CZ)

(21) Appl. No.: 19/173,399

(22) Filed: Apr. 8, 2025

Related U.S. Application Data
(60) Provisional application No. 63/761,131, filed on Feb. 20, 2025.

(51) Int. Cl. G06F 21/55

(52) U.S. Cl. CPC G06F 21/554; G06F 2221/034

(57) ABSTRACT

This disclosure describes techniques for an email security system to detect generative AI video threats in email. A system may receive an email that is to be delivered to a receiving user, where the system may determine that a video of the email is AI-generated. The system may identify segments of the video and determine whether the video includes an impersonation and/or malicious intent. In some instances, the system may determine the impersonation based on entity-specific data, such as an employee directory. Based on the impersonation and/or the malicious intent, the system may output a signal, or score, indicating a likelihood of maliciousness. The signal may be combined with other signals from other detections. A maliciousness verdict may be determined based on one or more signals, and usable by the system to determine whether to transmit the email to the receiving user, or perform a remedial action regarding the email.

### RELATED APPLICATIONS

This application claims priority to U.S. Provisional Application No. 63/761,131, filed Feb. 20, 2025, entitled “Detecting Generative Artificial Intelligence Video Threats in Email,” the entirety of which is herein incorporated by reference.

### TECHNICAL FIELD

The present disclosure relates generally to techniques for an email security system to detect generative artificial intelligence (AI) video for malicious email attacks.

### BACKGROUND

Electronic messages and mail, or “email,” continue to be a primary method of exchanging messages between users of electronic devices. Many email service providers have emerged that provide users with a variety of email platforms to facilitate the communication of emails via email servers that accept, forward, deliver, and store messages for the users. Email continues to be a fundamental method of communication between users of electronic devices as email provides users with a cheap, fast, accessible, efficient, and effective way to transmit all kinds of electronic data. Email is well established as a means of day-to-day, private communication for business communications, marketing communications, social communications, educational communications, and many other types of communications.

Due to the widespread use and necessity of email, scammers and other malicious entities use email as a primary channel for delivering different types of attacks, such as by business email compromise (BEC) attacks, malware attacks, and malware-less attacks. These malicious entities continue to employ more frequent and sophisticated social engineering techniques for deception and impersonation (e.g., phishing, spoofing, etc.). As users continue to become savvier about identifying malicious attacks on email communications, malicious entities similarly continue to evolve and improve methods of attack.

Accordingly, email security platforms are provided by email service providers (and/or third-party security service providers) that attempt to identify and eliminate attacks on email communication channels. For instance, cloud email services provide secure email gateways (SEGs) that monitor emails and implement pre-delivery protection by blocking email-based threats before they reach a mail server. These SEGs can scan incoming, outgoing, and internal communications for signs of malicious or harmful content, signs of social engineering attacks such as phishing or business email compromise, signs of data loss for compliance and data management, and other potentially harmful communications of data. However, with the rapid increase in the frequency and sophistication of attacks, it is difficult for email service providers to maintain their security mechanisms at the same rate as the rapidly changing landscape of malicious attacks on email communications.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system architecture of an example email security system.

FIG. 2 illustrates a diagram of example components of the email security system.

FIG. 3 illustrates a flow diagram of an example process for detecting a generative AI video email threats using entity-specific data.

FIG. 4 illustrates a flow diagram of an example process for detecting generative AI video threats in email.

FIG. 5 illustrates a computing system diagram illustrating a configuration for a data center that can be utilized to implement aspects of the technologies disclosed herein.

FIG. 6 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for an email security system to detect generative AI video threats in email, and using generative AI video threat detections along with other detections to determine a verdict and perform remedial actions. A method to perform the techniques described herein may include receiving, at an email platform and from a user data source, user data associated with a user registered with an email service, wherein the user data comprises user attributes. The method may further include receiving, at the email platform, an email to be delivered to an email account of the user registered with the email service, the email including video data. The method may further include determining, based at least in part on the email including video data, that the video data is artificial intelligence (AI)-generated video data, and identifying a portion of the AI-generated video data. The method may further include generating, by a first detector, a first severity signal based at least in part on the portion and the user data, and generating, by a second detector and based at least in part on the email, a second severity signal. The method may further include determining, based at least in part on the first severity signal and the second severity signal, a verdict whether the email is malicious. The method may further include processing the email based at least in part on the verdict.

Additionally, the techniques described herein may be performed by a system and/or device having non-transitory computer-readable media storing computer-executable instructions that, when executed by one or more processors, performs the method described above.

### Example Embodiments

Various implementations of the present disclosure provide techniques for an email security system to detect whether an email including a generative AI video is malicious. As discussed above, due to the widespread use and necessity of email, malicious entities use email as a primary channel for delivering different types of attacks, such as BEC scam emails. BEC scam emails include various types or classes, such as wire-transfer scams, gift card scams, payroll scams, invoice scams, acquisition scams, aging report scams, phone scams, a W-2 scam class, a merger and acquisition scam class, an executive forgery scam class, an attorney scam class, a tax client scam, an initial lure or rapport scam class, and so forth. In some instances, the scam attacks result in an organization or person under attack losing money or other financial resources. Additionally, or alternatively, the organization or person under attack may lose valuable information, such as trade secrets or other information. These malicious entities continue to employ more frequent and sophisticated social engineering techniques for deception and impersonation (e.g., phishing, spoofing, etc.). As users continue to become savvier about identifying malicious attacks on email communications, malicious entities similarly continue to evolve and improve methods of attack.

Accordingly, a need exists for systems and methods enabling an intelligent way to configure an email security system (e.g., SEG) to detect generative AI video threats in emails, where entity-specific (e.g., company-specific) data sources may be used to identify malicious AI-generated videos in email. According to the techniques described herein, an email security system may determine whether video data included in an email is AI-generated video data. Afterwards, based on (e.g., in response to) determining that the video data is AI-generated video data, the email security system may identify one or more segments, or portions, of the AI-generated video data. For example, a segment may include a video segment containing an individual, where the individual may be a potential candidate for impersonation detection. Additionally, or alternatively, a segment may include an audio segment, or text representing an audio segment, containing speech, where the speech may potentially include malicious content. Once one or more segments have been identified, the email security system may use, or work in combination with, a first detector that is configured to analyze content associated the one or more segments. For example, the first detector may determine whether the individual of a video segment is an employee of an entity (e.g., company), such as key personnel. In some instances, the first detector may determine whether the individual is an employee based on entity-specific data (e.g., company website, company directory, and/or the like). Additionally, or alternatively, the first detector may determine whether speech of an audio segment is associated with a malicious intent. Based on the analyzed content, the first detector may determine a severity signal, or score, indicating a prediction of maliciousness. The email security system may also use, or work in combination with, a second detector that is configured to analyze other email content and determine a severity signal. Both severity signals may be used to determine a verdict as to whether an email is malicious, and process the email accordingly. For example, the email security system may perform a remedial action such as quarantining the email in instances where a verdict indicates that the email is malicious. The email security system may transmit the email to a receiving user in instances where a verdict indicates that the email is malicious.

To implement the techniques described herein, an email service platform may use, or work in combination with, an email security system. The email security system (e.g., a SEG), may receive, or intercept, emails and/or other types of electronic communications that are to be communicated to users of the email service platform, such as being stored at a location that is accessible to the users via their respective inboxes. After receiving an email for a user (e.g., a receiving user) of the email service platform, the email security system may be configured to determine whether the email contains a video. For example, the email security system may be configured to extract email metadata including indications of video data included in the body of the email, as an attachment to the email, etc. While the techniques described herein refer to video data, it is to be appreciated that the techniques may similarly be applied to audio data, image data, and/or the like.

The email security system may also determine whether the video data included in the email is an AI-generated video. For example, the email security system may use, or work in combination with, a video data filter component in order to determine whether the video data is AI-generated. The email security system may include a machine learning model configured to detect one or more features, or artifacts, such as video and audio inconsistencies, unnatural eye blinking, artificial blurring, physical impossibilities, and/or the like. In instances where the video data included in the email is not AI-generated, the email security system may refrain from further processing, process the email using other detection models, etc. In instances where the video data included in the email is AI-generated, the email security system may further process the video data. For example, the email security system may use, or work in combination with, a video content extraction component that is configured to identify one or more portions, or segments of the video data. By way of example, and not limitation, a segment of the video data may include a video segment including, or depicting, an individual. In instances where video data includes a depiction of more than one individual, there may be more than one video segment. Additionally, or alternatively, a segment of the video data may depict an individual, actions associated with the individual (e.g., facial expressions, hand gestures, and/or the like), and/or other attributes associated with the individual (e.g., background, name on badge, etc.). Video segments of the video data may be determined using computer vision techniques. In some instances, a segment of the video data may include an audio segment, including, or depicting, speech audio. In instances where video data includes multiple instances of speech, there may be more than one audio segment. Audio segments of the video data may be determined using speech detection techniques. Additionally, or alternatively, audio segments of the video data may include, or be associated with, text data depicting the content of the audio data. As described in more detail below, the email security system may use entity-specific data. In some instances, segments of video data may be determined by the email security system based on the entity-specific data. For example, entity-specific data may only include image data. In such an example, the email security system may be configured to identify only video segments.

In some instances, the email security system may use, or work in combination with, a content analyzer component in order to perform one or more recognitions, classifications, computations, and/or the like associated with one or more segments of the video data. In some instances, the email security system may perform recognition operations using entity-specific data. For example, entity-specific data (e.g., company-specific data) may include an indication of one or more individuals (e.g., company employees in a directory, website, etc.). Indications of one or more individuals may include names, photographs, audio samples, and/or other personal identifying attributes. Additionally, or alternatively, entity-specific data may include an indication of prioritized individuals. By way of example, and not limitation, a prioritized individual may include high-level employees or key personnel of a company (e.g., CEO, CFO, general counsel, etc.). Entity-specific data may also include email data, financial data, security data, etc. associated with the entity. Additionally, or alternatively, entity-specific data may also include any publicly available information. The email security system may be configured to extract entity-specific data from one or more sources and/or receive entity-specific data from one or more sources. The email security system may extract and/or receive data at particular instances (e.g., a trigger event such as an update to a company directory), at particular intervals, etc.

As described above, the email security system may perform recognition operations using entity-specific data. In some instances, the email security system may determine that at least one of the segments of video data depicts an individual, speech, etc. that is sufficiently similar to the entity-specific data. By way of example, and not limitation, the email security system may determine that a CEO depicted in a video segment is sufficiently similar to an image of the CEO indicated in a company directory. Additionally, or alternatively, the email security may determine that a speech inflection depicted in an audio segment is sufficiently similar to an audio sample of the CEO (e.g., an audio sample from a recorded public interview with the CEO). Additionally, or alternatively, the email security system may determine that text data associated with an audio segment indicates that the CEO depicted in the video data introduces themselves as the CEO. In some instances, if the email security system determines that at least one segment of the video data is sufficiently similar to the entity-specific data, the system determines that the video data includes an impersonation. If the email security system determines that the segments of video data are insufficiently similar to the entity-specific data, the system determines that the video data does not include an impersonation. For example, AI-generated video data of an email may be for a legitimate use case (e.g., a company newsletter using AI avatars).

Additionally, or alternatively, the email security system may be configured to determine a malicious intent associated with one or more segments of the video data, such as a segment of audio data and/or a segment of text data. As described herein, the term “malicious” may be applied to data, actions, attackers, entities, emails, etc., and the term “malicious” may generally correspond to spam, phishing, callback phishing, spoofing, malware, viruses, and/or any other type of data, entities, or actions that may be considered or viewed as unwanted, negative, harmful, etc. for a recipient user and/or destination email address associated with an email communication. The email security system may use, or work in combination with, the content analyzer component to determine malicious intent. The email security system may be configured to determine malicious intent associated with a segment of audio data and/or text data using security analysis techniques. For example, the email security system may recognize specific behaviors, and/or the like. By way of example, and not limitation, the email security system may determine that the segment of video data includes a request for payment, a call-to-action, urgency, and/or other words commonly associated with BEC, spam, and/or spoofing attacks.

In some instances, the email security system may determine a signal (e.g., severity signal) indicating a prediction as to whether the AI-generated video data of the email is malicious. As described above, the email security system may use, or work in combination with, a video data filter component, a video content extraction component, and/or a content analyzer component. Additionally, or alternatively, the email system may include a first maliciousness detector model configured to output a severity signal, and comprising the video data filter component, the video content extraction component, and/or the content analyzer component. The first maliciousness detector model may determine a severity signal (e.g., prediction) about AI-generated video data based on one or more factors, such as based on at least one of the following: (i) whether the AI-generated video includes an impersonation, (ii) whether the AI-generated video data includes an impersonation of a prioritized individual, or (iii) whether the AI-generated video data is associated with a malicious intent. The severity signal may include a single score (e.g., a discrete or continuous score) determined by the first maliciousness detector model. Additionally, or alternatively, the factors used by the first maliciousness detector model to determine a severity signal may be equally weighted or have differing weights when factored together. By way of example, and not limitation, an indication that AI-generated video data includes an impersonation of a prioritized individual, that factor may be more heavily-weighted. A higher severity signal may indicate a higher likelihood that the email is a malicious email, whereas a lower severity signal may indicate a lower likelihood that the email is a malicious email.

In some instances, the email security system may determine one or more additional signals indicating a maliciousness prediction associated with the email using other maliciousness detector models, such as a second maliciousness detector model. For example, as described above, the email security system may be configured to extract email metadata. Email metadata may further include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine the malice.

The email security system may be configured to determine the intent of an incoming email based on the email metadata, and in turn, a severity signal (e.g., maliciousness prediction) using the second maliciousness detector model. The email metadata may be processed using security analysis techniques to determine whether the email is a scam email, phishing email, and/or other malicious email. For example, the email security system may determine that the email was sent from an email address associated with a malicious domain, the subject includes words commonly associated with phishing, spam, and/or spoofing attacks, URLs included in the email are to malicious websites, hashes of attachments correspond to malware attacks, and so forth.

In some examples, the email security system may be configured to aggregate and/or classify the maliciousness predictions. By way of example, and not limitation, the aggregation may be performed using an ensemble model, where an overall severity signal, such as a severity score, may be based on the output of a respective one of the maliciousness detector models and/or a single score (e.g., a discrete or continuous score) determined by aggregating the maliciousness detector models. By way of example, and continuing from the example above, a severity signal may be determined by aggregating the severity signal of the first maliciousness detector model and the severity signal of the second maliciousness detector model. In some cases, the severity signal may be, or include, a vector of a particular size. The vector may be determined by processing the severity signals, or outputs, of the maliciousness detector models using a machine learning model configured to determine a particularly-sized (e.g., a dimensionality-reduced) transformed representation of severity signals.

In some cases, the maliciousness prediction (e.g., severity signal) associated with the email is used to determine a maliciousness verdict for the email. In some cases, the maliciousness verdict for an email indicates whether the email is predicted to be associated with a malicious email attack. In some instances, the maliciousness verdict may be based on a severity signal (e.g., aggregated severity signal) meeting or exceeding a particular threshold (e.g., a severity score meeting or exceeding a particular threshold). Additionally, or alternatively, the maliciousness verdict may be based on one or more rules, policies, etc., which may be defined by an entity. In some cases, the maliciousness verdict for an email indicates a recommended remedial action for the email security system to perform concerning the email. Examples of remedial actions include blocking the email from being displayed in the inbox of the receiver, harvesting data about a malicious email to generate a maliciousness detector model, storing attacker data associated with a malicious email in a blocklist associated with the email security system, reporting attacker data associated with a malicious email to authorities, and/or the like.

The techniques described herein improve the function of email security systems, and thus prevent disastrous implications for individuals, enterprises, businesses, and/or the like (e.g., financial loss, emotional damage, etc.). For example, the techniques described herein can improve the effectiveness of an email security system by enabling the email security system to detect AI-generated video threats in email. Further, by using entity-specific data, the email security system may provide additional context for AI-generated content included in emails, and distinguish between legitimate AI-generated videos and AI-generated videos that are malicious. Further, a signal indicating a maliciousness prediction associated with an email including an AI-generated video may be used in combination with other detection signals to improve verdict accuracy. Accordingly, the techniques described herein improve an email security system's effectiveness and enhance computer system security.

Some of the techniques described herein are with reference to emails containing AI-generated videos. However, the techniques are generally applicable to any type of malicious email. Additionally, or alternatively, the techniques described herein are with reference to a network, such as a cloud provider network or platform, and networks such as VPCs, subnetworks (or “subnets”). However, the techniques are equally applicable to any network and in any environment. For example, the email security system may monitor an on-premises network.

Various implementations of the present disclosure will be described in detail with reference to the drawings, wherein like reference numerals present like parts and assemblies throughout the several views. Additionally, any samples set forth in this specification are not intended to be limiting and merely demonstrate some of the many possible implementations.

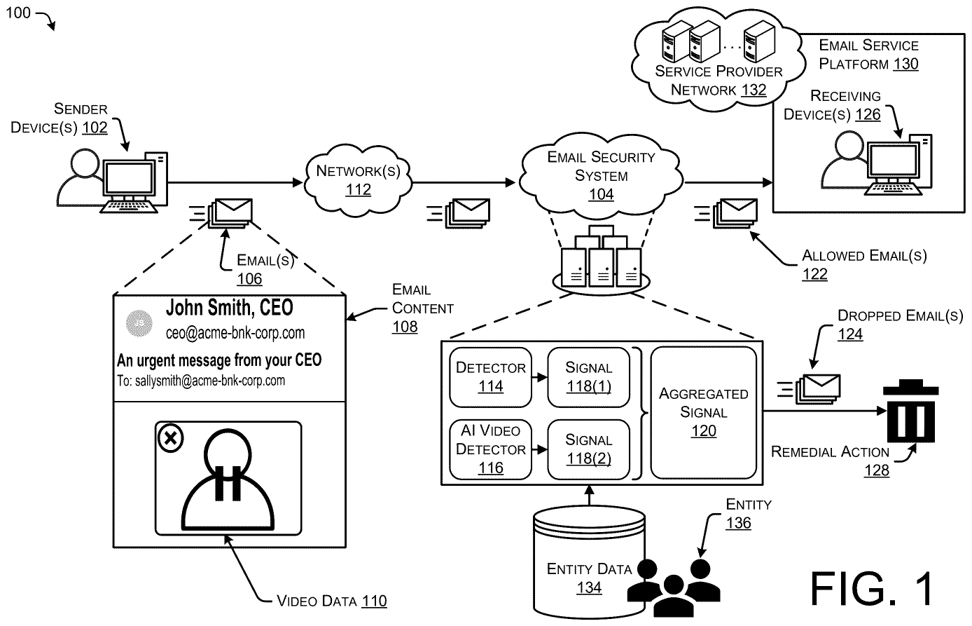

FIG. 1 illustrates a system architecture 100 of an example email security system 104 for detecting generative AI video threats in incoming emails 106 intended for users of receiving device(s) 126 of an email service platform 130, and processing the emails 106 accordingly.

In some examples, an email service platform 130 may be at a service provider network 132. The service provider network 132 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 132 may be an on-premises network, a private network of a corporation, and/or any other type of network or combination thereof.

Additionally, or alternatively, the email service platform 130 may use, or work in combination with, the email security system 104. The email security system 104 may be a scalable system that includes and/or runs on devices housed or located in one or more data centers, that may be located at different physical locations. In some examples, the email security system 104 may be included in the email service platform 130 and/or associated with a secure email gateway (SEG). The email security system 104 and the email service platform 130 may be supported by networks of devices in a public cloud computing platform, a private/enterprise computing platform, and/or any combination thereof. The one or more data centers may be physical facilities or buildings located across geographic areas that are designated to store network devices that are part of and/or support the email security system 104. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

The email security system 104 may be associated with the email service platform 130 of an email service provider, and may generally comprise any type of email and/or service provided by any provider, including public messaging service providers (e.g., Google Gmail, Microsoft Outlook, Yahoo! Mail, etc.), as well as private messaging service platforms maintained and/or operated by a private entity or enterprise. Further, the email service platform 130 may comprise cloud-based messaging service platforms (e.g., Google G Suite, Microsoft Office 365, etc.) that host messaging services. However, the email service platform 130 may generally comprise any type of platform for managing communication between clients or users, such as an email platform, a simple messaging service (SMS) platform, an audio/video communication platform, and so forth. The email service platform 130 may generally comprise a delivery engine behind email communications and include the requisite software and hardware for delivering email communications between users. For instance, an entity may operate and maintain the software and/or hardware of the email service platform 130 to allow users to send and receive emails, store and review emails in inboxes, manage and segment contact lists, build email templates, manage and modify inboxes and folders, scheduling, and/or any other operations performed using the email service platform 130.

The email service platform 130 may provide one or more messaging services to users of receiving device(s) 126 (or any type of user device) to enable the receiving device(s) 126 to communicate and/or receive emails. Sender device(s) 102 may communicate with receiving device(s) 126 over network(s) 112, such as the Internet. In some instances, the network(s) 112 may generally comprise one or more networks implemented by any viable communication technology, such as wired and/or wireless modalities and/or technologies. The network(s) 112 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed-and/or any combination, permutation, and/or aggregation thereof. The network(s) 112 may include devices, virtual resources, or other nodes that relay packets from one device to another.

User devices, such as the sender device(s) 102 that send emails 106 and the receiving device(s) 126 that receive the emails (e.g., allowed emails 122), may comprise any type of electronic device capable of communicating using email communications. For instance, the devices 102/126 may include one or more of different personal user devices, such as desktop computers, laptop computers, phones, tablets, wearable devices, entertainment devices such as televisions, and/or any other type of computing device. Thus, the devices 102/126 may utilize the email service platform 130 to communicate using emails based on email address domain name systems according to techniques known in the art.

As illustrated, the email security system 104 (e.g., a SEG), may receive, or intercept, emails 106 and/or other types of electronic communications that are to be communicated to receiving device(s) 126 of an email service platform 130 from sender device(s) 102, such as being stored at a location that is accessible to the users via their respective inboxes. After receiving an email for a user (e.g., a receiving device(s) 126) of the email service platform 130, the email security system 104 may be configured to determine whether the email 106 contains video data 110. For example, the email security system 104 may be configured to extract email metadata associated with the email content 108 including indications of video data 110 included in the body of the email, as an attachment to the email, etc. While the techniques described herein refer to video data 110, it is to be appreciated that the techniques may similarly be applied to audio data, image data, and/or the like.

The email security system 104 may use, or work in combination with, an AI video detector 116 to determine whether the video data 110 included in the email 106 is an AI-generated video. For example, the email security system 104 may include a machine learning model configured to detect one or more features, or artifacts, such as video and audio inconsistencies, unnatural eye blinking, artificial blurring, physical impossibilities, and/or the like. In instances where the video data 110 included in the email 106 is AI-generated, the email security system 104 may use, or work in combination with, AI video detector 116 to further process the video data 110. For example, the email security system 104 may identify one or more portions, or segments of the video data 110. By way of example, and not limitation, a segment of the video data 110 may include a video segment including, or depicting, an individual. In instances where video data 110 includes a depiction of more than one individual, there may be more than one video segment. Additionally, or alternatively, a segment of the video data 110 may depict an individual, actions associated with the individual (e.g., facial expressions, hand gestures, and/or the like), and/or other attributes associated with the individual (e.g., background, name on badge, etc.). Video segments of the video data 110 may be determined using computer vision techniques. In some instances, a segment of the video data 110 may include an audio segment, including, or depicting, speech audio. In instances where video data 110 includes multiple instances of speech, there may be more than one audio segment. Audio segments of the video data 110 may be determined using speech detection techniques. Additionally, or alternatively, audio segments of the video data 110 may include, or be associated with, text data depicting the content of the audio data. As described in more detail below, the email security system 104 may use entity data 134. In some instances, segments of video data 110 may be determined by the email security system 104 based on the entity data 134. For example, entity data 134 may only include image data. In such an example, the email security system 104 may be configured to identify only video segments.

In some instances, the email security system 104 may use, or work in combination with, AI video detector 116 to perform one or more recognitions, classifications, computations, and/or the like associated with one or more segments of the video data 110. In some instances, the email security system 104 may perform recognition operations using entity data 134. For example, entity data 134 (e.g., company-specific data) may include an indication of one or more individuals (e.g., company employees in a directory, website, etc.) associated with an entity 136. Indications of one or more individuals may include names, photographs, audio samples, and/or other personal identifying attributes. Additionally, or alternatively, entity data 134 may include an indication of prioritized individuals. By way of example, and not limitation, a prioritized individual may include high-level employees or key personnel of a company (e.g., CEO, CFO, general counsel, etc.). Entity data 134 may also include email data, financial data, security data, etc. associated with the entity. Additionally, or alternatively, entity data 134 may also include any publicly available information. The email security system 104 may be configured to extract entity data 134 from one or more sources and/or receive entity data 134 from one or more sources.

As described above, the email security system 104 may perform recognition operations using entity data 134. In some instances, the email security system 104 may determine that at least one of the segments of video data 110 depicts an individual, speech, etc. that is sufficiently similar to the entity data 134. By way of example, and not limitation, the email security system 104 may determine that a CEO depicted in a video segment is sufficiently similar to an image of the CEO indicated in a company directory. Additionally, or alternatively, the email security may determine that a speech inflection depicted in an audio segment is sufficiently similar to an audio sample of the CEO (e.g., an audio sample from a recorded public interview with the CEO). Additionally, or alternatively, the email security system 104 may determine that text data associated with an audio segment indicates that the CEO depicted in the video data 110 introduces themselves as the CEO. In some instances, if the email security system 104 determines that at least one segment of the video data 110 is sufficiently similar to the entity data 134, the system determines that the video data 110 includes an impersonation. If the email security system 104 determines that none of the segments of video data 110 are sufficiently similar to the entity data 134, the system determines that the video data 110 does not include an impersonation. For example, AI-generated video data 110 of an email may be for a legitimate use case (e.g., a company newsletter using AI avatars).

Additionally, or alternatively, the email security system 104 may use, or work in combination with, the AI video detector 116 to determine a malicious intent associated with one or more segments of the video data 110, such as a segment of audio data and/or a segment of text data. As described herein, the term “malicious” may be applied to data, actions, attackers, entities, emails, etc., and the term “malicious” may generally correspond to spam, phishing, callback phishing, spoofing, malware, viruses, and/or any other type of data, entities, or actions that may be considered or viewed as unwanted, negative, harmful, etc. for a recipient user and/or destination email address associated with an email communication. The email security system 104 may be configured to determine malicious intent associated with a segment of audio data and/or text data using security analysis techniques. For example, the email security system 104 may recognize specific behaviors, and/or the like. By way of example, and not limitation, the email security system 104 may determine that the segment of video data 110 includes a request for payment, a call-to-action, urgency, and/or other words commonly associated with BEC, spam, and/or spoofing attacks.

In some instances, the email security system 104 may determine a signal 118(2) (e.g., severity signal) indicating a prediction as to whether the AI-generated video data 110 of the email 106 is malicious. As described above, the email system may use, or work in combination with, AI video detector 116, (e.g., a first maliciousness detector model). The AI video detector 116 may be configured to output a signal 118(2). The AI video detector 116 may determine a severity signal (e.g., prediction) about AI-generated video data 110 based on one or more factors, such as based on at least one of the following: (i) whether the AI-generated video includes an impersonation, (ii) whether the AI-generated video data 110 includes an impersonation of a prioritized individual, or (iii) whether the AI-generated video data 110 is associated with a malicious intent. The signal 118(2) may include a single score (e.g., a discrete or continuous score) determined by the AI video detector 116. Additionally, or alternatively, the factors used by the AI video detector 116 to determine a severity signal may be equally weighted or have differing weights when factored together. By way of example, and not limitation, an indication that AI-generated video data 110 includes an impersonation of a prioritized individual, that factor may be more heavily-weighted. A higher signal 118 may indicate a higher likelihood that the email 106 is a malicious email, whereas a lower signal 118 may indicate a lower likelihood that the email 106 is a malicious email.

In some instances, the email security system 104 may determine one or more additional signals indicating a maliciousness prediction associated with the email 106 using other maliciousness detector models, such as a detector 114. For example, as described above, the email security system 104 may be configured to extract email metadata associated with the email content 108. Email metadata may further include, for example, indications of “From-Field” addresses and/or names for the email 106, “To-Field” addresses for the email, a “Subject” of the email, a Date/Time the email was communicated, hashes of attachments to the email, URLs in the body of the email, Internet Protocol (IP) addresses associated with the email, and/or a domain associated with the email 106 (e.g., the email server associated with an email address). In some instances, the metadata may additionally, or alternatively, include content included in the body of the email 106, actual attachments to the email 106, and/or other data of the email 106. Further, the metadata extracted from the email 106 may generally be any probative information for the email security system 104 to determine the malice.

The email security system 104 may be configured to determine the intent of an incoming email based on the email metadata, and in turn, a signal 118(1) (e.g., maliciousness prediction) using the detector 114. The email metadata may be processed using security analysis techniques to determine whether the email 106 is a scam email, phishing email, and/or other malicious email. For example, the email security system 104 may determine that the email 106 was sent from an email address associated with a malicious domain, the subject includes words commonly associated with phishing, spam, and/or spoofing attacks, URLs included in the email 106 are to malicious websites, hashes of attachments correspond to malware attacks, and so forth.

In some examples, the email security system 104 may be configured to aggregate and/or classify the maliciousness predictions. By way of example, and not limitation, the aggregation may be performed using an ensemble model, where an overall severity signal (e.g., aggregated signal 120) may be based on the output of a respective one of the detectors (e.g., detectors 114/116), and/or a single score (e.g., a discrete or continuous score) determined by aggregating the detectors. By way of example, and continuing from the example above, the aggregated signal 120 may be determined by aggregating the signal 118(2) of the AI video detector 116 and the signal 118(2) of the detector 114. In some cases, the signals may be, or include, a vector of a particular size. The vector may be determined by processing the signals, or outputs, of the detectors using a machine learning model configured to determine a particularly-sized (e.g., a dimensionality-reduced) transformed representation of severity signals.

Based on the aggregated signal 120, the email security system 104 may process the email 106 accordingly. For example, based on the aggregated signal 120, the email security system 104 may determine a maliciousness verdict for the email 106. In some cases, the maliciousness verdict for an email indicates whether the email 106 is predicted to be associated with a malicious email attack. In some cases, the maliciousness verdict for an email 106 indicates a recommended remedial action for the email security system 104 to perform concerning the email 106. For example, in instances where the email 106 is associated with a non-malicious verdict, the email security system 104 may be configured to forward and/or transmit the email 106 as an allowed email 122 to a receiving device(s) 126 such that the allowed email 122 is delivered to the receiving device(s) 126 user's inbox. In another example, in instances where the email 106 is associated with a maliciousness verdict, the email security system 104 may be configured to perform a remedial action 128 with respect to the email 106. Remedial actions 128 may include quarantining, flagging, deleting, and/or dropping the callback phishing attempt email, preventing further communication received from the sender device(s) 102 and/or further communication sharing similarities with the email 106, reporting sender device(s) 102 information and/or the phone number to authorities, and/or the like. As illustrated, the email 106 may be treated as a dropped email 124.

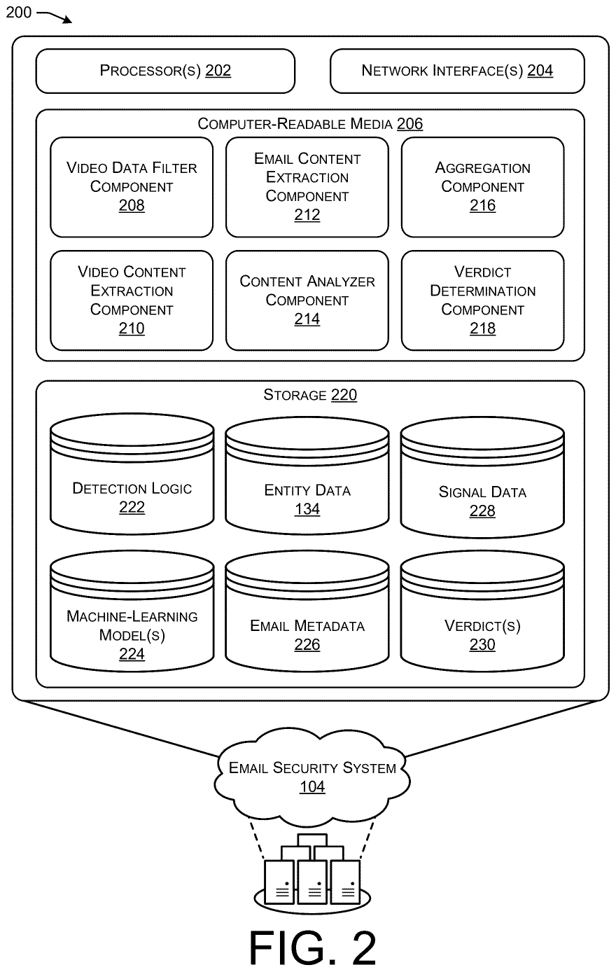

FIG. 2 illustrates a diagram 200 of example components of the email security system 104.

As illustrated, the email security system 104 may include one or more hardware processor(s) 202 (processors), one or more devices, configured to execute one or more stored instructions. The processor(s) 202 may comprise one or more cores. Further, the email security system 104 may include one or more network interfaces 204 configured to provide communications between the email security system 104 and other devices, such as the sending device(s) 102, receiving device(s) 126, and/or other systems or devices associated with an email service providing the email communications. The network interfaces 204 may include devices configured to couple to personal area networks (PANs), wired and wireless local area networks (LANs), wired and wireless wide area networks (WANs), and so forth. For example, the network interfaces 204 may include devices compatible with Ethernet, Wi-Fi™, and so forth.

The email security system 104 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the email security system 104. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the email security system 104 to perform various operations described herein. For example, the computer-readable media 206 may include video data filter component 208 that configures the email security system 104 to perform various operations described herein. For example, the video data filter component 208 may be configured to, when executed by the processor(s) 202, perform various techniques for determining whether video data is AI-generated. The video data filter component 208 may include a machine learning model configured to detect one or more features, or artifacts, such as video and audio inconsistencies, unnatural eye blinking, artificial blurring, physical impossibilities, and/or the like.

The computer-readable media 206 may further include a video content extraction component 210 that may configure the email security system 104 to perform various operations described herein. For instance, the video content extraction component 210 may be configured to, when executed by the processor(s) 202, perform various techniques for identifying one or more portions, or segments of the video data. By way of example, and not limitation, a segment of the video data may include a video segment including, or depicting, an individual. In instances where video data includes a depiction of more than one individual, there may be more than one video segment. Additionally, or alternatively, a segment of the video data may depict an individual, actions associated with the individual (e.g., facial expressions, hand gestures, and/or the like), and/or other attributes associated with the individual (e.g., background, name on badge, etc.). Video segments of the video data may be determined using computer vision techniques. In some instances, a segment of the video data may include an audio segment, including, or depicting, speech audio. In instances where video data includes multiple instances of speech, there may be more than one audio segment. Audio segments of the video data may be determined using speech detection techniques. Additionally, or alternatively, audio segments of the video data may include, or be associated with, text data depicting the content of the audio data. As described above, the email security system may use entity-specific data. In some instances, segments of video data may be determined by the video content extraction component 210 based on the entity-specific data. For example, entity-specific data may only include image data. In such an example, the video content extraction component 210 may be configured to identify only video segments.

The computer-readable media 206 may further include email content extraction component 212 that may configure the email security system 104 to perform various operations described herein. For instance, the email content extraction component 212 may be configured to, when executed by the processor(s) 202, perform various techniques for extracting email metadata to determine an email intent. Email metadata may further include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine the malice.

The computer-readable media 206 may further include a content analyzer component 214 that may configure the email security system 104 to perform various operations described herein. For instance, the content analyzer component 214 may be configured to, when executed by the processor(s) 202, perform various techniques for performing one or more recognitions, classifications, computations, and/or the like associated with one or more segments of the video data. In some instances, the email security system may perform recognition operations using entity-specific data. As described above, the email security system may perform recognition operations using entity-specific data. In some instances, the email security system may determine that at least one of the segments of video data depicts an individual, speech, etc. that is sufficiently similar to the entity-specific data. If the email security system determines that none of the segments of video data are sufficiently similar to the entity-specific data, the system determines that the video data does not include an impersonation. For example, AI-generated video data of an email may be for a legitimate use case (e.g., a company newsletter using AI avatars). The content analyzer component 214 may also be configured to, when executed by the processor(s) 202, perform various techniques for determining a malicious intent associated with one or more segments of the video data, such as a segment of audio data and/or a segment of text data. For example, the content analyzer component 214 may determine malicious intent associated with a segment of audio data and/or text data using security analysis techniques. For example, the content analyzer component 214 may recognize specific behaviors, and/or the like. By way of example, and not limitation, the content analyzer component 214 may determine that the segment of video data includes a request for payment, a call-to-action, urgency, and/or other words commonly associated with BEC, spam, and/or spoofing attacks.

The computer-readable media 206 may further include an aggregation component 216 that may configure the email security system 104 to perform various operations described herein. For instance, the aggregation component 216 may be configured to, when executed by the processor(s) 202, perform various techniques for aggregating severity signals output by one or more maliciousness detector models (e.g., detector 114 and/or AI video detector 116). For example, the aggregation component 216 may aggregate severity signals using an ensemble model, where an overall severity signal, such as a severity score, may be based on the output of a respective one of the maliciousness detector models and/or a single score (e.g., a discrete or continuous score) determined by aggregating the maliciousness detector models. By way of example, and continuing from the example above, a severity signal may be determined by aggregating the severity signal of the first maliciousness detector model and the severity signal of the second maliciousness detector model. In some cases, the severity signal may be, or include, a vector of a particular size. The vector may be determined by processing the severity signals, or outputs, of the maliciousness detector models using a machine learning model configured to determine a particularly-sized (e.g., a dimensionality-reduced) transformed representation of severity signals.

The computer-readable media 206 may further include verdict determination component 218 that may configure the email security system 104 to perform various operations described herein. For instance, the verdict determination component 218 may be configured to, when executed by the processor(s) 202, perform various techniques for determining a maliciousness verdict for the email. In some cases, the maliciousness verdict for an email indicates whether the email is predicted to be associated with a malicious email attack. In some cases, the maliciousness verdict for an email indicates a recommended remedial action for the email security system to perform concerning the email. Examples of remedial actions include blocking the email from being displayed in the inbox of the receiver, harvesting data about a malicious email to generate a maliciousness detector model, storing attacker data associated with a malicious email in a blocklist associated with the email security system, reporting attacker data associated with a malicious email to authorities, and/or the like.

The above-noted list of components and their respective processes are merely exemplary, and other types of security policies may be used to analyze the email and/or phone number metadata.

Additionally, the email security system 104 may include storage 220 which may comprise one, or multiple, repositories or other storage locations for persistently storing and managing collections of data such as databases, simple files, binary, and/or any other data. The storage 220 may include one or more storage locations that may be managed by one or more storage/database management systems.

As illustrated, the storage 220 may include detection logic 222, ML model(s) 224, entity data 134, email metadata 226, signal data 228, and/or verdict(s) 230. It should be appreciated that the foregoing list is merely exemplary and the storage 220 may include additional elements that may be apparent to one skilled in the art.

The detection logic 222 may include a database of logic for determining a maliciousness prediction (e.g., severity signal) by one or more maliciousness detector models. For example, content analyzer component 214 may reference detection logic 222 and/or entity data 134 in order to determine a maliciousness prediction.

The ML model(s) 224 may include a database of machine learning algorithms. The ML model(s) may include one or more algorithms including supervised, semi-supervised, unsupervised, and/or reinforcement. In some examples, the processor(s) 202 train(s) the email security system 104 utilizing machine learning techniques, statistical analysis, or any other means by which a system may be trained to output a detection of a malicious email based on input associated with received email information and/or other data associated with the storage 220.

The entity data 134 may include a database of entity-specific data. For example, entity data 134(e.g., company-specific data) may include an indication of one or more individuals (e.g., company employees in a directory, website, etc.). Indications of one or more individuals may include names, photographs, audio samples, and/or other personal identifying attributes. Additionally, or alternatively, entity data 134 may include an indication of prioritized individuals. By way of example, and not limitation, a prioritized individual may include high-level employees or key personnel of a company (e.g., CEO, CFO, general counsel, etc.). Entity data 134 may also include email data, financial data, security data, etc. associated with the entity. Additionally, or alternatively, entity data 134 may also include any publicly available information. The email security system may be configured to extract entity data 134 from one or more sources and/or receive entity data 134 from one or more sources. The email security system may extract and/or receive entity data 134 at particular instances (e.g., a trigger event such as an update to a company directory), at particular intervals, etc.

The email metadata 226 may include a database of email metadata (e.g., metadata indicating the content, attributes, and/or other information associated with an email). Email metadata may include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine the intent of the email (e.g., whether the intent is malicious). Additionally, or alternatively, the email metadata 226 may be a database of historically received and/or extracted email metadata.

The signal data 228 may include a database of severity signals output by one or more maliciousness detector models, and/or aggregations of severity signals. For example, a severity signal may indicate a prediction as to whether AI-generated video data of an email is malicious based on factors such as one of the following: (i) whether the AI-generated video includes an impersonation, (ii) whether the AI-generated video data includes an impersonation of a prioritized individual, or (iii) whether the AI-generated video data is associated with a malicious intent. A severity signal may indicate a prediction as to whether an email (e.g., the email containing the AI-generated video data) is malicious based on email metadata 226. As such, the signal data 228 may be used by the verdict determination component 218 to determine a maliciousness verdict of an email.

The verdict(s) 230 may store the results from the verdict determination component 218. For example, the verdict(s) 230 may be a database of historically classified emails (e.g., whether the email is associated with a maliciousness verdict). As such, the content analyzer component 214 and/or verdict determination component 218 may use verdict(s) 230 during their operations (e.g., determining subsequent severity signals and verdicts).

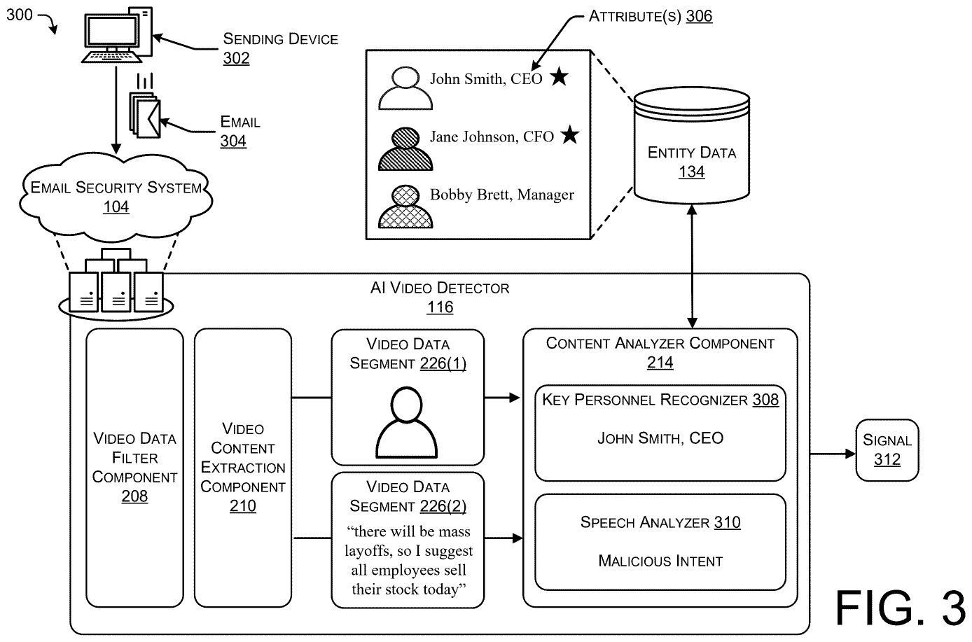

FIG. 3 illustrates a flow diagram of an example process 300 for detecting a generative AI video email threats using entity-specific data.

The email security system 104 may receive, or intercept, an email 304 from sending device 302 that is to be communicated to users of the email service platform. After receiving the email 304, the email security system 104 may be configured to determine whether the email 304 contains a video. For example, the email security system 104 may be configured to extract email metadata including indications of video data included in the body of the email, as an attachment to the email, etc. The email security system 104 may also determine whether the video data included in the email 304 is an AI-generated video. For example, the email security system 104 may use, or work in combination with, video data filter component 208 in order to determine whether the video data is AI-generated. The video data filter component 208 may include a machine learning model configured to detect one or more features, or artifacts, such as video and audio inconsistencies, unnatural eye blinking, artificial blurring, physical impossibilities, and/or the like.

Additionally, or alternatively, the email security system 104 may use, or work in combination with, video content extraction component 210 that is configured to identify one or more portions, or segments of the video data. By way of example, and not limitation, video data segment 226(1) may include a video segment including, or depicting, an individual. In some instances, video data segment 226(2) may include an audio segment, including, or depicting, speech audio. Additionally, or alternatively, the video data segment 226(2) may be associated with text data, or a text transcription, depicting the content of the video data segment 226(2) (e.g., “there will be mass layoffs, so I suggest all employees sell their stock today”). In some instances, the email security system 104 may use, or work in combination with, a content analyzer component 214 in order to perform one or more recognitions, classifications, computations, and/or the like associated with one or more segments of the video data. In some instances, the content analyzer component 214 may comprise a key personnel recognizer 308 to perform recognition operations using entity data 134. For example, entity data 134 (e.g., company-specific data) may include an indication of one or more individuals (e.g., company employees in a directory, website, etc.). As illustrated, entity data 134 may include a directory of company employees with attributes such as a photograph and name (e.g., John Smith, Jane Johnson, Bobby Brett). Additionally, or alternatively, entity data 134 may include an indication of prioritized individuals. By way of example, and not limitation, a prioritized individual may include high-level employees or key personnel of a company (e.g., CEO, CFO, general counsel, etc.). As illustrated, entity data 134 may include an attribute 306 indicating that John Smith and Jane Johnson are prioritized individuals. The key personnel recognizer 308 may determine that video segment 226(1) depicting a CEO is sufficiently similar to the image of the CEO (e.g., John Smith, CEO) indicated by the entity data 134. In some instances, if the key personnel recognizer 308 determines that the video data segment 226(1) is sufficiently similar to the entity-specific data, key personnel recognizer determines that the video data includes an impersonation.

Additionally, or alternatively, the content analyzer component 214 may be configured to determine a malicious intent associated with one or more segments of the video data, such as a video data segment 226(2) (e.g., including audio data and/or text data). The content analyzer component 214 may include a speech analyzer 310 configured to determine malicious intent associated with a segment of audio data and/or text data using security analysis techniques. For example, the email security system 104 may recognize specific behaviors, and/or the like. As illustrated, the speech analyzer 310 may determine that the video data segment 226(2) includes an urgent call-to-action that is financially-related, and may determine that the video data segment 226(2) is associated with malicious intent.

In some instances, video data filter component 208, video content extraction component 210, and/or content analyzer component 214 may comprise a maliciousness detector model (e.g., AI video detector 116), where the AI video detector 116 may determine a signal 312 indicating a prediction as to whether the AI-generated video data of the email 304 is malicious. The AI video detector 116 may determine the signal 312 based on one or more factors, such as based on at least one of the following: (i) whether the AI-generated video includes an impersonation, (ii) whether the AI-generated video data includes an impersonation of a prioritized individual, or (iii) whether the AI-generated video data is associated with a malicious intent. Based on the AI-generated video data of the email 304 including an impersonation of a prioritized individual, as well as malicious intent, the AI video detector 116 may output a signal 312 including a higher score indicating a higher likelihood that the email 304 is a malicious email.

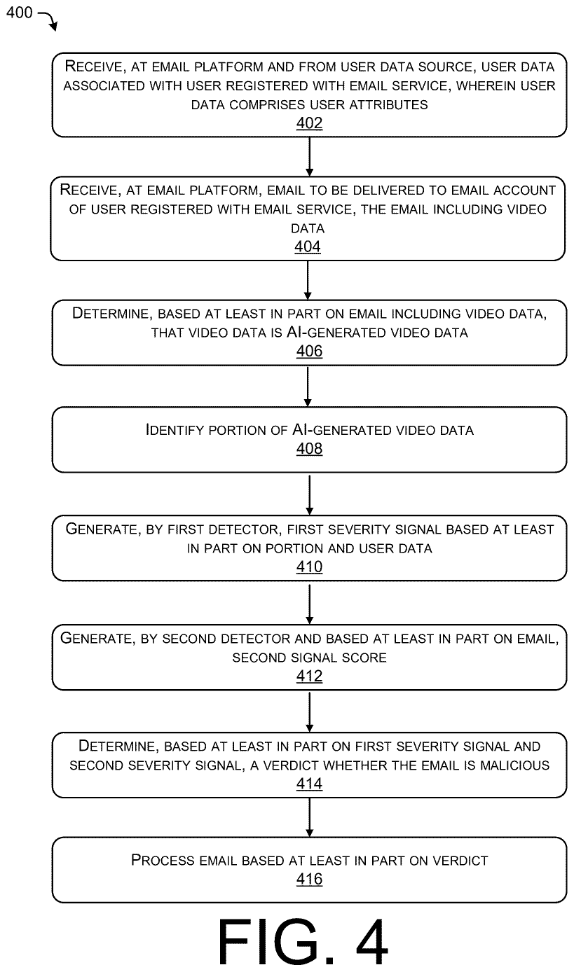

FIG. 4 illustrates a flow diagram of an example process for detecting generative AI video threats in email.

The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 402, the process 400 may include receiving, at an email platform and from a user data source, user data associated with a user registered with an email service, wherein the user data comprises user attributes. For example, entity-specific data (e.g., company-specific data) may include an indication of one or more individuals (e.g., company employees in a directory, website, etc.). Indications of one or more individuals may include names, photographs, audio samples, and/or other personal identifying attributes. Additionally, or alternatively, entity-specific data may include an indication of prioritized individuals. By way of example, and not limitation, a prioritized individual may include high-level employees or key personnel of a company (e.g., CEO, CFO, general counsel, etc.). Entity-specific data may also include email data, financial data, security data, etc. associated with the entity. Additionally, or alternatively, entity-specific data may also include any publicly available information. The email security system may be configured to extract entity-specific data from one or more sources and/or receive entity-specific data from one or more sources. The email security system may extract and/or receive data at particular instances (e.g., a trigger event such as an update to a company directory), at particular intervals, etc.

At block 404, the process 400 may include receiving, at the email platform, an email to be delivered to an email account of the user registered with the email service, the email including video data. For example, the email security system (e.g., a SEG), may receive, or intercept, emails and/or other types of electronic communications that are to be communicated to users of the email service platform, such as being stored at a location that is accessible to the users via their respective inboxes. After receiving an email for a user (e.g., a receiving user) of the email service platform, the email security system may be configured to determine whether the email contains a video. For example, the email security system may be configured to extract email metadata including indications of video data included in the body of the email, as an attachment to the email, etc.

At block 406, the process 400 may include determining, based at least in part on the email including video data, that the video data is artificial intelligence (AI)-generated video data. For example, the email security system may also determine whether the video data included in the email is an AI-generated video. For example, the email security system may use, or work in combination with, a video data filter component in order to determine whether the video data is AI-generated. The email security system may include a machine learning model configured to detect one or more features, or artifacts, such as video and audio inconsistencies, unnatural eye blinking, artificial blurring, physical impossibilities, and/or the like.

At block 408, the process 400 may include identifying a portion of the AI-generated video data. For example, the email security system may use, or work in combination with, a video content extraction component that is configured to identify one or more portions, or segments of the video data. By way of example, and not limitation, a segment of the video data may include a video segment including, or depicting, an individual. In instances where video data includes a depiction of more than one individual, there may be more than one video segment. Additionally, or alternatively, a segment of the video data may depict an individual, actions associated with the individual (e.g., facial expressions, hand gestures, and/or the like), and/or other attributes associated with the individual (e.g., background, name on badge, etc.). Video segments of the video data may be determined using computer vision techniques. In some instances, a segment of the video data may include an audio segment, including, or depicting, speech audio. In instances where video data includes multiple instances of speech, there may be more than one audio segment. Audio segments of the video data may be determined using speech detection techniques. Additionally, or alternatively, audio segments of the video data may include, or be associated with, text data depicting the content of the audio data.

At block 410, the process 400 may include generating, by a first detector, a first severity score based at least in part on the portion and the user data. For example, the email security system may perform recognition operations using entity-specific data. In some instances, the email security system may determine that at least one of the segments of video data depicts an individual, speech, etc. that is sufficiently similar to the entity-specific data. By way of example, and not limitation, the email security system may determine that a CEO depicted in a video segment is sufficiently similar to an image of the CEO indicated in a company directory. Additionally, or alternatively, the email security may determine that a speech inflection depicted in an audio segment is sufficiently similar to an audio sample of the CEO (e.g., an audio sample from a recorded public interview with the CEO). Additionally, or alternatively, the email security system may determine that text data associated with an audio segment indicates that the CEO depicted in the video data introduces themselves as the CEO. In some instances, if the email security system determines that at least one segment of the video data is sufficiently similar to the entity-specific data, the system determines that the video data includes an impersonation.

In some instances, the email security system may determine a signal (e.g., severity signal) indicating a prediction as to whether the AI-generated video data of the email is malicious. As described above, the email security system may use, or work in combination with, a video data filter component, a video content extraction component, and/or a content analyzer component. Additionally, or alternatively, the email system may include a first maliciousness detector model configured to output a severity signal, and comprising the video data filter component, the video content extraction component, and/or the content analyzer component. The first maliciousness detector model may determine a severity signal (e.g., prediction) about AI-generated video data based on one or more factors, such as based on at least one of the following: (i) whether the AI-generated video includes an impersonation, (ii) whether the AI-generated video data includes an impersonation of a prioritized individual, or (iii) whether the AI-generated video data is associated with a malicious intent. The severity signal may include a single score (e.g., a discrete or continuous score) determined by the first maliciousness detector model. Additionally, or alternatively, the factors used by the first maliciousness detector model to determine a severity signal may be equally weighted or have differing weights when factored together. By way of example, and not limitation, an indication that AI-generated video data includes an impersonation of a prioritized individual, that factor may be more heavily-weighted. A higher severity signal may indicate a higher likelihood that the email is a malicious email, whereas a lower severity signal may indicate a lower likelihood that the email is a malicious email.

At block 412, the process 400 may include generating, by a second detector and based at least in part on the email, a second severity score. For example, the email security system may be configured to determine a malicious intent associated with one or more segments of the video data, such as a segment of audio data and/or a segment of text data. As described herein, the term “malicious” may be applied to data, actions, attackers, entities, emails, etc., and the term “malicious” may generally correspond to spam, phishing, callback phishing, spoofing, malware, viruses, and/or any other type of data, entities, or actions that may be considered or viewed as unwanted, negative, harmful, etc. for a recipient user and/or destination email address associated with an email communication. The email security system may use, or work in combination with, the content analyzer component to determine malicious intent. The email security system may be configured to determine malicious intent associated with a segment of audio data and/or text data using security analysis techniques. For example, the email security system may recognize specific behaviors, and/or the like. By way of example, and not limitation, the email security system may determine that the segment of video data includes a request for payment, a call-to-action, urgency, and/or other words commonly associated with BEC, spam, and/or spoofing attacks.

In some instances, the email security system may determine one or more additional signals indicating a maliciousness prediction associated with the email using other maliciousness detector models, such as a second maliciousness detector model. For example, as described above, the email security system may be configured to extract email metadata. Email metadata may further include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine the malice.

The email security system may be configured to determine the intent of an incoming email based on the email metadata, and in turn, a severity signal (e.g., maliciousness prediction) using the second maliciousness detector model. The email metadata may be processed using security analysis techniques to determine whether the email is a scam email, phishing email, and/or other malicious email. For example, the email security system may determine that the email was sent from an email address associated with a malicious domain, the subject includes words commonly associated with phishing, spam, and/or spoofing attacks, URLs included in the email are to malicious websites, hashes of attachments correspond to malware attacks, and so forth.

At block 414, the process 400 may include determining, based at least in part on the first severity score and the second severity score, a verdict whether the email is malicious. For example, the maliciousness prediction (e.g., severity signal) associated with the email is used to determine a maliciousness verdict for the email. In some cases, the maliciousness verdict for an email indicates whether the email is predicted to be associated with a malicious email attack. In some instances, the maliciousness verdict may be based on a severity signal (e.g., aggregated severity signal) meeting or exceeding a particular threshold (e.g., a severity score meeting or exceeding a particular threshold). Additionally, or alternatively, the maliciousness verdict may be based on one or more rules, policies, etc., which may be defined by an entity.

At block 416, the process 400 may include processing the email based at least in part on the verdict. For example, the maliciousness verdict for an email indicates a recommended remedial action for the email security system to perform concerning the email. Examples of remedial actions include blocking the email from being displayed in the inbox of the receiver, harvesting data about a malicious email to generate a maliciousness detector model, storing attacker data associated with a malicious email in a blocklist associated with the email security system, reporting attacker data associated with a malicious email to authorities, and/or the like.

Additionally, or alternatively, the process 400 may include, wherein the portion of AI-generated video data comprises at least one of a video segment depicting an individual, or an audio segment comprising speech associated with an individual.

Additionally, or alternatively, the process 400 may include determining a threshold severity associated with the verdict, wherein the first severity score does not violate the threshold severity, determining, based at least in part on the first severity score, the verdict, the verdict indicating that the email is not malicious, generating an aggregate severity score, the aggregate severity score comprising the first severity score and the second severity score, and determining that the aggregate severity score violates the threshold severity, wherein determining the verdict is based on the aggregate severity score violating the threshold severity, the verdict, the verdict indicating that the email is malicious.

Additionally, or alternatively, the process 400 may include, wherein the user data comprises an entity directory, and the portion of the AI-generated video data comprises a video segment depicting a first individual, determining a second individual associated with the entity directory, and determining a comparison between the first individual and the second individual, wherein generating the first severity score is further based at least in part on the comparison.

Additionally, or alternatively, the process 400 may include, wherein the entity directory includes an indication of prioritized individuals, determining that the prioritized individuals comprise the second individual associated with the entity directory, and based at least in part on the prioritized individuals comprising the second individual, determining a weight, wherein generating the first severity score is further based at least in part on the weight.

Additionally, or alternatively, the process 400 may include, wherein the user data comprises entity data, and the portion of the AI-generated video data comprises an audio segment comprising speech associated with an individual, determining text data associated with the audio segment, and determining a comparison between the text data and the entity data, wherein generating the first severity score is further based at least in part on the comparison.

Additionally, or alternatively, the process 400 may include wherein processing the email based at least in part on the verdict includes, based on the verdict indicating that the email is malicious, refraining from transmitting the email to the user, or based on the verdict indicating that the email is not malicious, causing the email to be transmitted to the user.

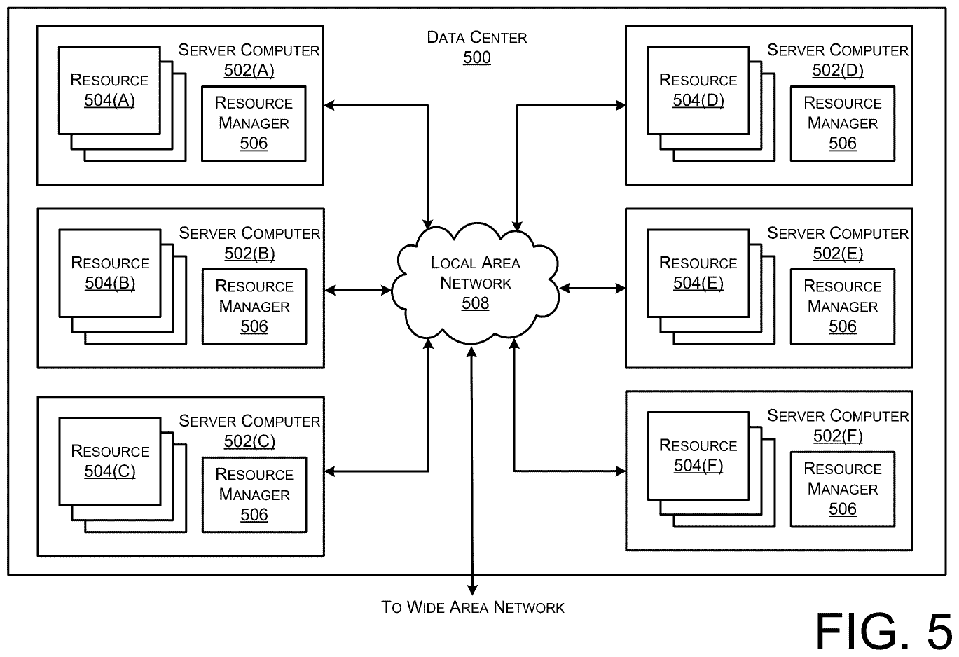

FIG. 5 is a computing system diagram illustrating a configuration for a data center 500 that can be utilized to implement aspects of the technologies disclosed herein. In one example, the data center 500 may be used to support the email security system 104 and/or the service provider network 132. The example data center 500 shown in FIG. 5 includes several server computers 502A-502F (which might be referred to herein singularly as “a server computer 502” or in the plural as “the server computers 502”) for providing computing resources. In some examples, the resources and/or server computers 502 may include, or correspond to, any type of networked device described herein. Although described as servers, the server computers 502 may comprise any type of networked device, such as servers, switches, routers, hubs, bridges, gateways, modems, repeaters, access points, etc.

The server computers 502 can be standard tower, rack-mount, or blade server computers configured appropriately for providing computing resources. In some examples, the server computers 502 may provide computing resources 504 including data processing resources such as VM instances or hardware computing systems, database clusters, computing clusters, storage clusters, data storage resources, database resources, networking resources, and others. Some of the server computers 502 can also be configured to execute a resource manager 506 capable of instantiating and/or managing the computing resources. In the case of VM instances, for example, the resource manager 506 can be a hypervisor or another type of program configured to enable the execution of multiple VM instances on a single server computer 502. Server computers 502 in the data center 500 can also be configured to provide network services and other types of services. In one example, server computers 502 may be used to support the email security system 104 and/or the service provider network 132.

In the example data center 500 shown in FIG. 5, an appropriate LAN 508 is also utilized to interconnect the server computers 502A-502F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 500, between each of the server computers 502A-502F in each data center 500, and, potentially, between computing resources in each of the server computers 502. It should be appreciated that the configuration of the data center 500 described with reference to FIG. 5 is merely illustrative and that other implementations can be utilized.

In some examples, the server computers 502 may each execute one or more application containers and/or virtual machines to perform techniques described herein.

In some instances, the data center 500 may provide computing resources, like application containers, VM instances, and storage, on a permanent or an as-needed basis. Among other types of functionality, the computing resources provided by a cloud computing network may be utilized to implement the various services and techniques described above. The computing resources 504 provided by the cloud computing network can include various types of computing resources, such as data processing resources like application containers and VM instances, data storage resources, networking resources, data communication resources, network services, and the like.

Each type of computing resource 504 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 504 not mentioned specifically herein.

The computing resources 504 provided by a cloud computing network may be enabled in one embodiment by one or more data centers 500 (which might be referred to herein singularly as “a data center 500” or in the plural as “the data centers 500”). The data centers 500 are facilities utilized to house and operate computer systems and associated components. The data centers 500 typically include redundant and backup power, communications, cooling, and security systems. The data centers 500 can also be located in geographically disparate locations. One illustrative embodiment for a data center 500 that can be utilized to implement the technologies disclosed herein will be described below with regard to FIG. 5.

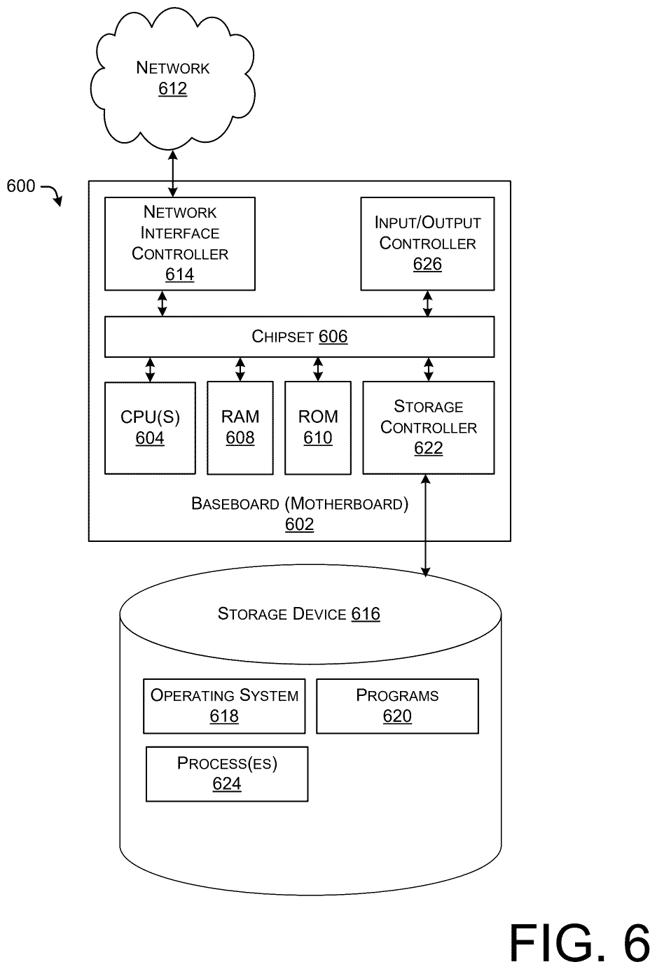

FIG. 6 is a computer architecture diagram showing an illustrative computer hardware architecture for implementing a computing device (e.g., computer 600) that can be utilized to implement aspects of the various technologies presented herein. The computer architecture shown in FIG. 6 illustrates a conventional server computer, workstation, desktop computer, laptop, tablet, network appliance, e-reader, smartphone, or other computing device, and can be utilized to execute any of the software components presented herein. The computer 600 may, in some examples, correspond to a network node described herein.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a random-access memory (RAM) 608, used as the main memory in the computer 600. The chipset 606 can further provide an interface to a computer-readable storage medium such as a read-only memory (ROM) 610 or non-volatile RAM (NVRAM) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 612. The chipset 606 can include functionality for providing network connectivity through a network interface controller (NIC) 614, such as a gigabit Ethernet adapter. The NIC 614 is capable of connecting the computer 600 to other computing devices over the network 612. It should be appreciated that multiple NICs 614 can be present in the computer 600, connecting the computer 600 to other types of networks and remote computer systems. In some instances, the NICs 614 may include at least one ingress port and/or at least one egress port.

The computer 600 can be connected to a storage device 616 that provides non-volatile storage for the computer. The storage device 616 can store an operating system 618, programs 620, and data, which have been described in greater detail herein. The storage device 616 can be connected to the computer 600 through a storage controller 622 connected to the chipset 606. The storage device 616 can consist of one or more physical storage units. The storage controller 622 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 600 can store data on the storage device 616 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 616 is characterized as primary or secondary storage, and the like.

For example, the computer 600 can store information to the storage device 616 by issuing instructions through the storage controller 622 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 616 by detecting the physical states or characteristics of one or more particular locations within the physical storage units.

In addition to the mass storage device 616 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by any network node described herein may be supported by one or more devices similar to computer 600. Stated otherwise, some or all of the operations performed by a network node may be performed by one or more computers 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 616 can store an operating system 618 utilized to control the operation of the computer 600. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 616 can store other system or application programs and data utilized by the computer 600.

In one embodiment, the storage device 616 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

As illustrated in FIG. 6, the storage device 616 stores programs 620, which may include one or more processes 624. The process(es) 624 may include instructions that, when executed by the CPU(s) 604, cause the computer 600 and/or the CPU(s) 604 to perform one or more operations.

The computer 600 can also include at least one input/output controller 626 for receiving and processing input from a number of input devices, such as a keyboard, a mouse, a touchpad, a touch screen, an electronic stylus, or other type of input device. Similarly, an input/output controller 626 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A method comprising:
receiving, at an email platform and from a user data source, user data associated with a user registered with an email service, wherein the user data comprises user attributes;
receiving, at the email platform, an email to be delivered to an email account of the user registered with the email service, the email including video data;
determining, based at least in part on the email including video data, that the video data is artificial intelligence (AI)-generated video data;
identifying a portion of the AI-generated video data;
generating, by a first detector, a first severity score based at least in part on the portion and the user data;
generating, by a second detector and based at least in part on the email, a second severity score;
determining, based at least in part on the first severity score and the second severity score, a verdict whether the email is malicious; and
processing the email based at least in part on the verdict.

2. The method of claim 1, wherein the portion of AI-generated video data comprises at least one of:
a video segment depicting an individual; or
an audio segment comprising speech associated with an individual.

3. The method of claim 1, further comprising:
determining a threshold severity associated with the verdict, wherein the first severity score does not violate the threshold severity;
determining, based at least in part on the first severity score, the verdict, the verdict indicating that the email is not malicious;
generating an aggregate severity score, the aggregate severity score comprising the first severity score and the second severity score; and
determining that the aggregate severity score violates the threshold severity,
wherein determining the verdict is based on the aggregate severity score violating the threshold severity, the verdict, the verdict indicating that the email is malicious.

4. The method of claim 1, wherein the user data comprises an entity directory, and the portion of the AI-generated video data comprises a video segment depicting a first individual, the method further comprising:
determining a second individual associated with the entity directory; and
determining a comparison between the first individual and the second individual, wherein generating the first severity score is further based at least in part on the comparison.

5. The method of claim 4, wherein the entity directory includes an indication of prioritized individuals, the method further comprising:
determining that the prioritized individuals comprise the second individual associated with the entity directory; and
based at least in part on the prioritized individuals comprising the second individual, determining a weight, wherein generating the first severity score is further based at least in part on the weight.

6. The method of claim 1, wherein the user data comprises entity data, and the portion of the AI-generated video data comprises an audio segment comprising speech associated with an individual, the method further comprising:
determining text data associated with the audio segment; and
determining a comparison between the text data and the entity data, wherein generating the first severity score is further based at least in part on the comparison.

7. The method of claim 1, wherein processing the email based at least in part on the verdict includes:
based on the verdict indicating that the email is malicious, refraining from transmitting the email to the user; or
based on the verdict indicating that the email is not malicious, causing the email to be transmitted to the user.

8. An email security system comprising:
one or more processors; and
one or more non-transitory computer-readable media storing computer-executable instructions that, when executed by the one or more processors, cause the one or more processors to perform operations comprising:
receiving, at an email platform and from a user data source, user data associated with a user registered with an email service, wherein the user data comprises user attributes;
receiving, at the email platform, an email to be delivered to an email account of the user registered with the email service, the email including video data;
determining, based at least in part on the email including video data, that the video data is artificial intelligence (AI)-generated video data;
identifying a portion of the AI-generated video data;
generating, by a first detector, a first severity score based at least in part on the portion and the user data;
generating, by a second detector and based at least in part on the email, a second severity score;
determining, based at least in part on the first severity score and the second severity score, a verdict whether the email is malicious; and
processing the email based at least in part on the verdict.

9. The email security system of claim 8, wherein the portion of AI-generated video data comprises at least one of:
a video segment depicting an individual; or
an audio segment comprising speech associated with an individual.

10. The email security system of claim 8, the operations further comprising:
determining a threshold severity associated with the verdict, wherein the first severity score does not violate the threshold severity;
determining, based at least in part on the first severity score, the verdict, the verdict indicating that the email is not malicious;
generating an aggregate severity score, the aggregate severity score comprising the first severity score and the second severity score; and
determining that the aggregate severity score violates the threshold severity,
wherein determining the verdict is based on the aggregate severity score violating the threshold severity, the verdict, the verdict indicating that the email is malicious.

11. The email security system of claim 8, wherein the user data comprises an entity directory, and the portion of the AI-generated video data comprises a video segment depicting a first individual, the operations further comprising:
determining a second individual associated with the entity directory; and
determining a comparison between the first individual and the second individual, wherein generating the first severity score is further based at least in part on the comparison.

12. The email security system of claim 11, wherein the entity directory includes an indication of prioritized individuals, the operations further comprising:
determining that the prioritized individuals comprise the second individual associated with the entity directory; and
based at least in part on the prioritized individuals comprising the second individual, determining a weight, wherein generating the first severity score is further based at least in part on the weight.

13. The email security system of claim 8, wherein the user data comprises entity data, and the portion of the AI-generated video data comprises an audio segment comprising speech associated with an individual, the operations further comprising:
determining text data associated with the audio segment; and
determining a comparison between the text data and the entity data, wherein generating the first severity score is further based at least in part on the comparison.

14. The email security system of claim 8, wherein processing the email based at least in part on the verdict includes:
based on the verdict indicating that the email is malicious, refraining from transmitting the email to the user; or
based on the verdict indicating that the email is not malicious, causing the email to be transmitted to the user.

15. One or more non-transitory computer-readable media storing computer-executable instructions that, when executed by one or more processors, cause the one or more processors to perform operations comprising:
receiving, at an email platform and from a user data source, user data associated with a user registered with an email service, wherein the user data comprises user attributes;
receiving, at the email platform, an email to be delivered to an email account of the user registered with the email service, the email including video data;
determining, based at least in part on the email including video data, that the video data is artificial intelligence (AI)-generated video data;
identifying a portion of the AI-generated video data;
generating, by a first detector, a first severity score based at least in part on the portion and the user data;
generating, by a second detector and based at least in part on the email, a second severity score;
determining, based at least in part on the first severity score and the second severity score, a verdict whether the email is malicious; and
processing the email based at least in part on the verdict.

16. The one or more non-transitory computer-readable media of claim 15, wherein the portion of AI-generated video data comprises at least one of:
a video segment depicting an individual; or
an audio segment comprising speech associated with an individual.

17. The one or more non-transitory computer-readable media of claim 15, the operations further comprising:
determining a threshold severity associated with the verdict, wherein the first severity score does not violate the threshold severity;
determining, based at least in part on the first severity score, the verdict, the verdict indicating that the email is not malicious;
generating an aggregate severity score, the aggregate severity score comprising the first severity score and the second severity score; and
determining that the aggregate severity score violates the threshold severity,
wherein determining the verdict is based on the aggregate severity score violating the threshold severity, the verdict, the verdict indicating that the email is malicious.

18. The one or more non-transitory computer-readable media of claim 15, wherein the user data comprises an entity directory, and the portion of the AI-generated video data comprises a video segment depicting a first individual, the operations further comprising:
determining a second individual associated with the entity directory; and
determining a comparison between the first individual and the second individual, wherein generating the first severity score is further based at least in part on the comparison.

19. The one or more non-transitory computer-readable media of claim 18, wherein the entity directory includes an indication of prioritized individuals, the operations further comprising:
determining that the prioritized individuals comprise the second individual associated with the entity directory; and
based at least in part on the prioritized individuals comprising the second individual, determining a weight, wherein generating the first severity score is further based at least in part on the weight.

20. The one or more non-transitory computer-readable media of claim 15, wherein the user data comprises entity data, and the portion of the AI-generated video data comprises an audio segment comprising speech associated with an individual, the operations further comprising:
determining text data associated with the audio segment; and
determining a comparison between the text data and the entity data, wherein generating the first severity score is further based at least in part on the comparison.
